(19) United States
(12) Patent Application Publication
(10) Pub. No.: US 2005/0250887 A1
(43) Pub. Date: Nov. 10, 2005

(54) Emulsion type acrylic pressure sensitive adhesives

(76) Inventors: Bin-Yen Yang, Taipei City (TW); Wataru Shimokawa, Tokyo (JP); Chi-Lin Kao, Taipei City (TW); Chao-Yo Lin, Zhong He City (TW)

Correspondence Address: J C PATENTS, INC., 4 VENTURE, SUITE 250, IRVINE, CA, 92618, US

(21) Appl. No.: 10/884,147

(22) Filed: Jul. 1, 2004

(30) Foreign Application Priority Data
May 5, 2004 (TW) 93112611

(51) Int. Cl. C08L 1/00

(52) U.S. Cl. 524/156; 524/556; 525/330.3

(57) ABSTRACT

The invention relates to a composition of an emulsion type, acrylic, pressure sensitive adhesive, which includes (a) 15 to 35 parts per hundred of dialkyl dicarboxylate, (b) 15 to 35 parts per hundred of vinyl esters, (c) 35 to 65 parts per hundred of alkyl acrylates or alkyl mathacrylates; (d) 0.1 to 2.0 parts per hundred of cross-linker based on the total weight of (a)+(b)+(c), (e) 0.2˜2.0 parts per hundred of hydroxy alkyl acrylates or hydroxy alkyl mathacrylates, (f) 0.1 to 1.0 parts per hundred nonionic surfactant, (g) 0.4 to 3.0 parts per hundred of anionic surfactant, (h) 0.1˜0.5 parts per hundred of reactive surfactant; which react with de-ionized water, an initiator and a buffer. The adhesives composition has excellent water-whitening resistance and aging resistance properties.

### CROSS-REFERENCE TO RELATED APPLICATION

This application claims the priority benefit of Taiwan application serial no. 93112611, filed May 5, 2004.

### BACKGROLND OF THE INVENTION

1. Field of the Invention

The present invention relates to a type of adhesive. More particularly, the present invention relates to an emulsion type, acrylic, pressure sensitive adhesive with the properties of water-whitening resistance and aging resistance.

2. Description of the Related Art

As the society becomes more aware of the significance of environmental protection, industrial products, even the commonly used product, such as adhesive that is harmful to the ecological environment are gradually being replaced and eliminated. The solvent-type of adhesive is steadily going off the market. Among the emulsion type of adhesives the acrylic pressure sensitive adhesive is broadly used, especially in the application of label product. However, when this type of transparent label, which is formed with the emulsion type acrylic pressure sensitive adhesive (simply known as emulsion adhesive) is attached to a bottle, it is desirable that the adhesive can remain transparent even in a high moisture environment for a long period of time.

However, it is difficult to achieve the above-mentioned characteristic. Since, many water sensitive materials are added during the polymerization of emulsion adhesive, for example emulsifier for stabilizing emulsion, polar monomers for enhancing the peel adhesion and mechanical stability (for example, monomers that contain carboxylic acid groups, such as acrylic acid, methyacrylic acid, itaconic acid) and a small amount of electrolytes, such as an initiator. This type of emulsion adhesive forms a transparent film when drying, and an interface still presents between the emulsion particles. The interface provides a channel for water molecules to diffuse into the film. As water diffuses into the film, the refraction index at the interface between the emulsion particles becomes greater, leading to the scattering of light and the whitening of the emulsion adhesive, and adversely affecting the visual appearance of the adhesive.

Asides from the above-mentioned shortcomings, when this type of adhesive is coated on a calcium carbonate (CaCO₃) substrate of a synthetic paper, a coated paper or a neutral paper, the adhesive properties, such as loop tack, steel peel adhesion, PE peel adhesion, deteriorate drastically. Since the interior of the calcium carbonate substrate contains moisture, the water molecules and calcium carbonate react and break down into Ca⁺² and Co₃⁻², wherein Ca⁺² and COOH in the adhesive further form ˜2COO⁻Ca⁺² due to a chelating effect, leading to the deterioration of the adhesive properties.

### SUMMARY OF THE INVENTION

Accordingly, the present invention provides an emulsion type acrylic pressure sensitive adhesive. Besides having a high peel adhesion, the adhesive of the present invention also has the properties of water-whitening resistance and aging resistance.

In accordance to the present invention, an emulsion type acrylic pressure sensitive adhesive having the water-whitening resistance and aging resistance properties is provided. The composition of this type of pressure sensitive adhesive includes: (a) 15 to 35 part per hundred of dialkyl dicarboxylate monomers; (b) 15 to 35 part per hundred of vinyl esters monomers; (c) 35 to 65 parts per hundred of alkyl acrylate monomers or alkyl methacrylate monomers; (d) 0.1 to 2.0 parts per hundred of a cross-linker based on the total weight of (a)+(b)+(c); (e) 0.2 to 2.0 parts per hundred of hydroxy alkyl acrylate monomers or hydroxy alkyl mathacrylate; (f) 0.1 to 1.0 parts per hundred of a nonionic surfactant; (g) 0.4 to 3.0 parts per hundred of an anionic surfactant; (h) 0.1 to 0.5 parts per hundred of reactive surfactant. The emulsion type acrylic pressure sensitive adhesive is formed after the above components are reacted with an appropriate amount of deionized water, initiator and buffer. The emulsion type acrylic pressure sensitive adhesive of the present invention has an average particle diameter between about 0.1˜0.5 microns, a glass transition temperature (Tg) between about −50˜−20° C. and a solid content of about 30%-70% by weight (wt. %).

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### DESCRIPTION OF THE PREFERRED EMBODIMENTS

The emulsion type acrylic pressure sensitive adhesive of the present invention can be produced by an emulsion polymerization method. According to an embodiment, the composition of the emulsion type acrylic pressure sensitive adhesive includes of:
(a) dialkyl dicarboxylate monomers, 15 to 35 parts per hundred, wherein dialkyl dicarboxylate is, for example, dioctyl maleate, dipropyl maleate, dibutyl maleate, dioctyl fumarate, dipropyl furmarate, or dibutyl furmarate;
(b) vinyl esters monomers, for example, vinyl butyrate, allyl acetate, vinyl isobutyrate or vinyl acetate, 15 to 35 parts per hundred;
(c) alkyl acrylate or alkyl methacrylate monomers, 35 to 65 parts per hundred, wherein alkyl acrylate is for example, ethyl acrylate, butyl acrylate, 2-ethyl hexyl methacrylate, decyl acrylate or ethyl hexyl acrylate; while alkyl methacrylates is, for example, methyl methacrylate, butyl methylacrylate;
(d) cross-linker, for example, metal chelating agent, epoxy, silane, ethyl ethoxy acetoacetoxy ethyl methacrylate or acetoacetoxy butyl methacrylate, 0.1 to 2.0 parts per hundred, based on the total weight of (a)+(b)+(c).
(e) hydroxy alkyl acrylate or hydroxy alkyl methacrylate monomers, wherein based on the total weight of (a)+(b)+(c), hydroxy alkyl acrylate is about 0.2 to 2.0 parts per hundred and is, for example, hydroxy ethyl acrylate or hydroxy propyl acrylate; while hydroxy alkyl methacrylate is about 0.2 to 2.0 parts per hundred and is, for example, hydroxy ethyl methacrylate or hydroxy propyl methacrylate.

The emulsion type acrylic pressure sensitive adhesive of the present invention can be formed by mixing with different types of surfactants to provide a stable emulsion during the polymerization of the emulsion, and for the end product to have a high peel adhesion, a desirable film forming characteristic, water whitening resistance and aging resistance properties. The various types of surfactant include mixtures of nonionic surfactant, anionic surfactant and reactive surfactant, wherein the content of the surfactant is 0.5 to 4.5 parts per hundred, based on the total weight of (a)+(b)+(c).
(f) the nonionic surfactant, for example, polyoxethyene nonyl phenyl ether, polyoxethyene octyl phenyl ether, polyethylene glycol alkyl phenol ether, diallyl aliphatic acid ester, or polyethylene glycol diallyl aliphatic acid ester, is about 0.1 to 2.0 parts per hundred based on the total weight (a)+(b)+(c);
(g) the anionic surfactant, for example, sodium dodecylbenzosulfonate, sodium dodecylsulfonate, disodium dodecyl sulfonate phenyl ether, disodium n-stearyl succinate sulfonate or ammonium polyoxethyene nonyl phenyl ether sulfate, is about 0.4 to 3.0 parts per hundred based on the total weight (a)+(b)+(c);
(h) the reactive surfactant, for example, JS2, RS-30 (Sanyo Chemical Company, Japan), NE-10, NE-20, NE-300R SE-100 (Asahi Denka Co., Ltd, Japan), is about 0.1 to 0.5 parts per hundred based on the total weight (a)+(b)+(c).

The monomer composition of the emulsion type acrylic pressure sensitive adhesive begins to react with each other through at least one initiator, a buffer and deionized water. The amount of the initiator is about 0.1 to 2.0 parts per hundred based on the total weight of (a)+(b)+(c). The initiator can be, for example, sodium persulfate, ammonium persulfate or potassium persulfate. The amount of the buffer is 0.1 to 0.5 parts per hundred based on the total weight of (a)+(b)+(c). The buffer can be, for example, sodium bicarbonate or sodium acetate.

With the presence of the above (f), (g) and (h) surfactant mixtures, an appropriate amount of deionized water, initiator and buffer, the above (a), (b), (c), (d) and (e) monomers in the reaction tank begin to react under heating to form emulsion adhesive particles, under reaction temperature of 50° C.-90° C. for about 5-10 hours of reaction time.

In the aforementioned reaction, the dialkyl maleate monomers or dialkyl furmarate monomers (a), the vinly esters monomers (b), the alkyl acrylate monomers or alkyl methacrylate monomers (c), the cross-linker (d), the hydroxy alkyl acrylate monomers or hydroxy alkyl methacrylate monomers (e), the nonionic surfactant (f), the anionic surfactant (g), the reactive surfactant (h) are used. Deionized water, the initiator and the buffer can be added continuously or semi-continuously. The emulsion adhesive of the present invention has an average particle diameter between about 0.1˜0.5 microns, a glass transit temperature (Tg) between about −50˜−20° C. and a solid content of about 30%-70% by weight (wt. %).

Preparation of the emulsion type, acrylic; pressure sensitive adhesive of the present invention is described as follow.

### First Embodiment

0.25 g of ammonium•polyoxethyene nonyl phenyl ether sulfate (Chun-Zih Synthesis Company, Taiwan) and 2.74 gm of NE-10 (Asahi Denka Co., Ltd, Japan) are evenly mixed in 40 g of de-ionized water to obtain solution A.

70.5 g of de-ionized water, 3.08 g of polyoxethyene nonyl phenyl ether (Chun-Zih Synthesis Company, Taiwan), 18.22 g of ammonium•polyoxethyene nonyl phenyl ether sulfate, 153.9 g of 2-ethyl hexyl methacrylate monomers, 102.6 g of dioctyl maleate monomers, 85.5 g of vinyl acetate monomers, 3.42 g of hydroxy ethyl acrylate and 1.03 g of ethyl acetoxy ethyl methacrylate monomers are evenly mixed to obtain the solution B.

87.5 g of de-ionized water, 1.8 g of sodium bicarbonate and 0.9 g of potassium persulfate are evenly mixed to prepare solution C.

20.5 g of de-ionized water and 0.9 g of potassium persulfate are mixed to prepare solution D.

The solution A and a half quantity (½) of the solution D are poured into the emulsion and polymerization apparatus, which includes a stirrer, a thermometer, a heater, a reflux condenser, a five neck flask and a one-liter round bottom flask. When the solution is heated to about 69 to 70° C., a mixture of 1/10 of the solution B and ½ of the solution D is steadily fed into the emulsion and polymerization apparatus within 20-30 minutes. The mixture is then heated to 79 to 81° C., and the remaining of solution B ( 9/10 of the weight) and the solution C are slowly fed into the emulsion and polymerization apparatus within 240 minutes. Thereafter, the reaction temperature is increased to 85 to 87° C. and is maintained for 90 minutes, and is then cooled to the room temperature. The resultant emulsion acrylic type, pressure sensitive adhesive has a solid content of about 60%, a pH value of 5.2, a viscosity 14000 cps. The physical properties of the product are shown in Table 1.

### Second Embodiment

0.25 g of ammonium polyoxethyene nonyl phenyl ether sulfate (Chun-Zih Synthesis Company, Taiwan) and 2.74 g of RS-30 (Asahi Denka Co., Ltd, Japan) are evenly mixed in 40 g of de-ionized water to obtain solution A.

70.5 g of de-ionized water, 3.08 g of polyoxethyene nonyl phenyl ether (Chun-Zih Synthesis Company, Taiwan), 18.22 g of ammonium polyoxethyene nonyl phenyl ether sulfate, 153.9 g of 2-ethyl hexyl methacrylate monomers, 102.6 g of dioctyl maleate monomers, 85.5 g of vinyl acetate monomers, 3.42 g of hydroxy ethyl acrylate and 1.03 g of acetoacetoxy ethy methacrylate monomers are evenly mixed to obtain the solution B.

87.5 g of de-ionized water, 1.8 g of sodium bicarbonate and 0.9 g of potassium persulfate are evenly mixed to prepare solution C.

20.5 g of de-ionized water and 0.9 g of potassium persulfate are mixed to prepare solution D.

The solution A and a half quantity (½) of the solution D are poured into the emulsion and polymerization apparatus, which includes a stirrer, a thermometer, a heater, a reflux condenser, a five neck flask and a one-liter round bottom flask. When the solution is heated to about 69 to 70° C., the mixture of 1/10 of the solution B and ½ of the solution D is steadily fed into the emulsion and polymerization apparatus within 20-30 minutes. The mixture is then heated to 79 to 81° C., and the remaining solution B ( 9/10 of the weight) and the solution C are slowly fed into the emulsion and polymerization apparatus within 240 minutes. Thereafter, the reaction temperature is increased to 85 to 87° C. and is maintained for 90 minutes, and is then cooled to the room temperature. The resultant emulsion type, acrylic, pressure sensitive adhesive has a solid content of 60%, pH 4.8, viscosity 9000 cps. The physical properties of this product are shown in Table 1.

### Comparison to Embodiment 1

0.25 g of ammonium polyoxethyene nonyl phenyl ether sulfate (Chun-Zih Synthesis Company, Taiwan) is evenly mixed in 40 g of de-ionized water to obtain solution A.

70.5 g of de-ionized water, 3.08 g of polyoxethyene nonyl phenyl ether (Chun-Zih Synthesis Company, Taiwan), 18.22 g of ammonium polyoxethyene nonyl phenyl ether sulfate, 153.9 g of 2-ethyl hexyl methacrylate monomers, 102.6 g of dioctyl maleate monomers, 85.5 g of vinyl acetate monomers, 3.42 g of hydroxy ethyl acrylate and 1.03 g of acetoacetoxy ethy methacrylate monomers are evenly mixed to obtain the solution B.

87.5 g of de-ionized water, 1.8 g of sodium bicarbonate and 0.9 g of potassium persulfate are evenly mixed to prepare solution C.

20.5 g of de-ionized water and 0.9 g of potassium persulfate are mixed to prepare solution D.

The solution A and a half quantity (½) of the solution D are poured in to the emulsion and polymerization apparatus, which includes a stirrer, a thermometer, a heater, a reflux condenser, a five neck flask and a one-liter round bottom flask. When the solution is heated to about 69 to 70° C., the mixture of 1/10 of the solution B and ½ of the solution D is steadily fed into the emulsion and polymerization apparatus within 20-30 minutes. The mixture is then heated to 79 to 81° C., and the remaining solution B ( 9/10 of the weight) and the solution C are slowly fed within 240 minutes into the emulsion and polymerization apparatus. Thereafter, the reaction temperature is increased to 85 to 87° C. and is maintained for 90 minutes, and then cooled to the room temperature. The resultant product has a solid content of 60%, a pH value of 5.1, a viscosity of 9500 cps. The physical properties of this product are shown in Table 1.

### Comparison of Embodiment 2

The product is obtained following the procedures in embodiment 1 with the addition of 3.42 g of acrylic acid of and of methacrylic acid. The physical properties of this product are shown in Table 1.

TABLE 1
Physical Properties of the products formed according to the
procedures in Embodiment 1, Embodiment 2, Comparison of
Embodiment 1, Comparison of Embodiment 2.

| | | | Comparison | Comparison |
|---|---|---|---|---|
| | Embodi- | Embodi- | of Embodi- | of Embodi- |
| | ment 1 | ment 2 | ment 1 | ment 2 |
| Particle size (nm) | 160 | 150 | 150 | 150 |
| Solid content (%) | 60.0 | 60.0 | 60.0 | 60.0 |
| Viscosity (cps) | 14000 | 9000 | 8400 | 9800 |
| Loop tack (kg/in) | 1.60 | 1.30 | 1.20 | 1.08 |
| Steel adhesion | 1.40 | 1.70 | 1.30 | 1.63 |
| (kg/in) | | | | |
| PE adhesion (kg/in) | 0.80 | 0.67 | 0.58 | 0.54 |
| Holding power | 8000 | 8200 | 4500 | 9000 |
| (min) | | | | |

Coating conditions: the thickness of the PP synthetic paper is 80 μm; the thickness of the adhesive is 22 ± 0.2 μm.

The differences in the products of Embodiment 1, Embodiment 2, Comparison of Embodiment 1, Comparison of Embodiment 2.

The differences in the products of Embodiment 1, Embodiment 2,
Comparison of Embodiment 1, Comparison of Embodiment 2.

| | | | Comparison | Comparison |
|---|---|---|---|---|
| | Embodi- | Embodi- | of Embodi- | of Embodi- |
| | ment 1 | ment 2 | ment 1 | ment 2 |
| NE-10 | ∘ | x | x | ∘ |
| Reactive surfactant | | | | |
| RS-30 | x | ∘ | x | x |
| Reactive surfactant | | | | |
| Acrylic acid | x | x | x | ∘ |
| monomers | | | | |
| Methacrylic acid | x | x | x | ∘ |
| monomers | | | | |

∘: with the addition; x without the addition

As shown in Table 1, the product in embodiment 1 contains NE-10 reactive surfactant, the product in embodiment 2 contains RS-30 reactive surfactant, the product in the comparison of embodiment 1 does not contain any reactive surfactant. The product in the comparison of embodiment 2 contains NE-10 reactive surfactant, acrylic acid monomers and methacrylic acid monomers.

TABLE 2
Test results on water-whitening resistance

| | Water-whitening resistance | | | |
|---|---|---|---|---|
| | | | Comparison | Comparison |
| Water-bath | Embodi- | Embodi- | of Embodi- | of Embodi- |
| temperature | ment 1 | ment 2 | ment 1 | ment 2 |
| 25° C. | ⊚ | ⊚ | Δ | Δ |
| 40° C. | ⊚ | ⊚ | x | x |
| 70° C. | ∘ | Δ | x | x |

Coating conditions: the thickness of the polyester film is 25 μm; the thickness of the adhesive is 22±0.2 μm.

Regarding the water-whitening resistance test, please refer to the following “Test Method” section.
⊚ greater than 60 minutes, the polyester film remains transparent.
◯ between 30˜60 minutes, the polyester film remains transparent, but turns lightly milky white.
Δ between 10˜30 minutes, the polyester film turns semi-transparent and milky white
x within 10 minutes, the polyester film turns opaque and milky white.

According to the table above, the products of embodiment 1 and embodiment 2 display desirable water-whitening resistance property after being subjected to the water-whitening resistance test. The water-whitening resistance of the product of comparison of embodiment 1, in which reactive surfactant is not used, the water-whitening resistance property is undesirable. The product of comparison of embodiment 2, which is the same as the product of embodiment 1 with the addition of acrylic acid and methacrylic acid monomers, displays a less desirable water-whitening resistance property.

Test Methods:
1. Solid content (%): after measuring the weight of a plate (a), 0.5 g of emulsion adhesive (b) is placed on the plate and both are put into an oven at 150° C. for 1 hour. Then the plate and emulsion adhesive are then weighted (c). The calculation formulation: solid content (%)={(c−a)/b}*100.
2. Viscosity: measured by a Brookfield viscosimeter, at 25° C., 4# rotating rod/30 rpm.
3. Steel peel adhesion (kg/in): according to ASTM D-1000 standards.
4. PE peel adhesion (kg/in): according to ASTM D-1000 standards.
5. Loop tack (kg/in): a sample size of 25×200 mm, the adhesive surface facing downwards and both ends overlapping for 25 mm to form a loop. The tape is in contact with a steel plate and the tape is moved up at a speed of 300 mm/min, so as to calculate the maximum adhesion when the tape is separated from the steel plate.
6. Holding power (min): according to PSTC-7 tape testing standards, a sample size of 25×25 mm is glued to the steel plate and a weight is 1 kg. The retaining time is recorded.
7. Water-whitening resistance: samples with the dimension of 25 mm×200 mm are soaked in water baths of 25, 40 and 70 degrees Celsius, respectively, followed by observing and recording the color changes of the samples.

The Effect Tests:

The results of the aging resistance effect of the products of embodiment 1, embodiment 2, comparison of embodiment 1, comparison of embodiment 2 are summarized in Tables 3, 4, 5 and 6.

TABLE 3
Test results on the aging resistance effects

| | Aging resistance effect | | | |
|---|---|---|---|---|
| | Product of Embodiment 1 | | | |
| | | Steel peel | PE peel | |
| | Loop tack | adhesion | adhesion | Holding power |
| 60° C./day | (kg/in) | (kg/in) | (kg/in) | (min) |
| 0 day | 1.60 | 1.40 | 0.80 | 8000 |
| 1 day | 1.62 | 1.50 | 0.76 | 7890 |
| 3 days | 1.56 | 1.42 | 0.78 | 8100 |
| 7 days | 1.58 | 1.38 | 0.75 | 8150 |

Coating conditions: the thickness of the synthetic paper is 80 μm; the thickness of the adhesive is 22 ± 0.2 μm.

TABLE 4
Test results on the aging resistance effect

| | Aging resistance effect | | | |
|---|---|---|---|---|
| | Product of Embodiment 2 | | | |
| | | Steel peel | PE peel | |
| | Loop tack | adhesion | adhesion | Holding power |
| 60° C./day | (kg/in) | (kg/in) | (kg/in) | (min) |
| 0 day | 1.30 | 1.70 | 0.67 | 8200 |
| 1 day | 1.30 | 1.68 | 0.84 | 8230 |
| 3 days | 1.28 | 1.70 | 0.64 | 8200 |
| 7 days | 1.27 | 1.70 | 0.69 | 8300 |

Coating conditions: the thickness of the synthetic paper is 80 μm; the thickness of the adhesive is 22 ± 0.2 μm.

TABLE 5
Test results on the aging resistance adhesion effects

| | Aging resistance effect | | | |
|---|---|---|---|---|
| | Product of Comparison of Embodiment 1 | | | |
| | Loop tack | Steel adhesion | PE adhesion | Holding power |
| 60° C./day | (kg/in) | (kg/in) | (kg/in) | (min) |
| 0 day | 1.20 | 1.30 | 0.58 | 4500 |
| 1 day | 1.20 | 1.25 | 0.58 | 4620 |
| 3 days | 1.17 | 1.26 | 0.61 | 4635 |
| 7 days | 1.16 | 1.25 | 0.57 | 4660 |

Coating conditions: the thickness of the synthetic paper is 80 μm; the thickness of the glue is 22 ± 0.2 μm.

TABLE 6
Test results on the aging resistance adhesion effects

| | Aging resistance effect | | | |
|---|---|---|---|---|
| | Product of Comparison of Embodiment 2 | | | |
| | Loop tack | Steel adhesion | PE adhesion | Holding power |
| 60° C./day | (kg/in) | (kg/in) | (kg/in) | (min) |
| 0 day | 1.08 | 1.63 | 0.54 | 9000 |
| 1 day | 0.98 | 0.86 | 0.51 | 9800 |
| 3 days | 0.73 | 0.68 | 0.49 | 10000 |
| 7 days | 0.64 | 0.65 | 0.41 | 12000 |

Coating conditions: the thickness of the synthetic paper is 80 μm; the thickness of the adhesive is 22 ± 0.2 μm.

As shown in Tables 3, 4, 5, and 6, the products of embodiment 1 and embodiment 2 display desirable aging resistance effect (refer to Table 3 and table 4). The product of the comparison of embodiment 1 displays acceptable aging resistance effect. The product of the comparison of embodiment 2 is the same as that of embodiment 1 with the addition of acrylic acid and methacrylic acid monomers. The loop tack, steel adhesion and PE adhesion become less desirable for the product of the comparison of embodiment 2, while the holding power improves (see table 6).

In accordance to the disclosure above of the present invention, a mixture of appropriate proportions of dialkyl dicarboxylate monomers, vinyl esters monomers, alkyl acrylates (or alkyl methacrylates) monomers, cross-linker, hydroxy alkyl acrylates (or hydroxy alkyl methacrylate) with nonionic surfactant, anionic surfactant and reactive surfactant is heated and reacted to form an emulsion adhesive product, wherein this product not only has a high degree of adhesiveness, it has also the water-whitening resistance and aging resistance properties.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. An acrylic, pressure sensitive adhesive, comprising:
(a) 15 to 35 parts per hundred of dialkyl dicarboxylate monomers;
(b) 15 to 35 parts per hundred of vinyl esters monomers;
(c) 35 to 65 parts per hundred of alkyl acrylate monomers or alkyl methacrylate monomers;
(d) 0.1 to 2.0 parts per hundred of a cross-linker;
(e) 0.2 to 2.0 parts per hundred of hydroxy alkyl acrylate monomers or hydroxy alkyl methacrylate monomers;
(f) 0.1 to 1.0 parts per hundred of a nonionic surfactant;
(g) 0.4 to 3.0 parts per hundred of an anionic surfactant; and
(h) 0.1 to 0.5 parts per hundred of a reactive surfactant;
wherein a total weight of (a)+(b)+(c) is 100 weight percent, while (d), (e), (f) and (g) are added based on the total weight of (a)+(b)+(c), and the adhesive is formed by reacting components (a) to (h) with deionized water, a buffer and an initiator.

2. The acrylic, pressure sensitive adhesive of claim 1, wherein the dialkyl dicarboxylate monomers are selected from the group of monomers consisting of dioctyl maleate, dipropyl maleate, dibutyl maleate, dioctyl fumarate, dipropyl furmarate, and dibutyl furmarate.

3. The acrylic, pressure sensitive adhesive of claim 1, wherein the vinyl esters monomers are selected from the group of monomers consisting of vinyl butyrate, allyl acetate, vinyl isobutyrate or vinyl acetate.

4. The acrylic, pressure sensitive adhesive of claim 1, wherein the alkyl acrylates monomers are selected from the group of monomers consisting of butyl acrylate, 2-ethyl hexyl methacrylate, decyl acrylate, and ethyl hexyl acrylate.

5. The acrylic, pressure sensitive adhesive of claim 1, wherein the alkyl methacrylates monomers are methyl methacrylate or butyl methylacrylate.

6. The acrylic, pressure sensitive adhesive of claim 1, wherein the cross-linker is selected from the group consisting of a metal chelating agent, epoxy, silane, ethyl acetocetoxy ethyl mathacrylate or acetoacetoxy butyl mathacrylate.

7. The acrylic, pressure sensitive adhesive of claim 1, wherein the hydroxy alkyl acrylate monomers are hydroxy ethyl acrylate or hydroxy propyl acrylate.

8. The acrylic, pressure sensitive adhesive of claim 1, wherein the hydroxy alkyl methyacrylate monomers are hydroxy ethyl methacrylate or hydroxy propyl methacrylate.

9. The acrylic, pressure sensitive adhesive of claim 1, wherein the nonionic surfactant is selected from the group of surfactants consisting of polyoxethyene nonyl phenyl ether, polyoxethyene octyl phenyl ether, polyethylene glycol alkyl phenol ether, diallyl aliphatic acid ester and polyethylene glycol diallyl aliphatic acid ester.

10. The acrylic, pressure sensitive adhesive of claim 1, wherein the anionic surfactant is selected from the group consisting of sodium dodecylbenzosulfonate, sodium dodecylsulfonate, disodium dodecyl sulfonate phenyl ether, disodium n-stearyl succinate sulfonate and ammonium polyoxethyene nonyl phenyl ether sulfate.

11. The acrylic, pressure sensitive adhesive of claim 1, wherein the reactive surfactant is selected from the group consisting of JS2, RS-30, NE-10, NE-20, NE-30 and SE-100.
